(19) United States
(12) Patent Application Publication
(10) Pub. No.: US 2012/0118964 A1
(43) Pub. Date: May 17, 2012

(54) ALTERING AN IMAGING PARAMETER TO READ A SYMBOL

(76) Inventors: Timothy Paul James Kindberg, Bristol (GB); Andraw C. Goris, Loveland, CO (US); Timothy Louis Kohier, San Jose, CA (US)

(21) Appl. No.: 13/122,433

(22) PCT Filed: Oct. 22, 2008
(86) PCT No.: PCT/US08/80796

§ 371 Date: Apr. 4, 2011

(51) Int. Cl. G06K 7/10

(52) U.S. Cl. 235/454

(57) ABSTRACT

In a method of reading a symbol that depicts computer-readable information, an image is obtained and a determination as to whether the image contains a suspected symbol is made. At least one imaging parameter is altered to enhance recognition of the suspected symbol in response to a determination that the image contains a suspected symbol. In addition, the suspected symbol is read from at least one of an image altered with the at least one imaging parameter and a second image obtained with the at least one imaging parameter altered.

### RELATED APPLICATIONS

The present invention is related to GB Ser. No. 0714666.5 (Attorney Docket Number 200701359), titled, “Content Encoder and Decoder and Methods of Encoding and Decoding Content,” filed on Jul. 27, 2007; GB Ser. No. 0714664.0 (Attorney Docket Number 200701360), titled, “An Encoder and Decoder And Methods of Encoding and Decoding Sequence Information,” filed on Jul. 27, 2007; GB Ser. No. 0714661.6 (Attorney Docket Number 200701398), titled, “A Method of Generating a Sequence of Display-Frames for Display on a Display Device” filed on Jul. 27, 2008; Application Ser. No. TBD (Attorney Docket Number 200704392), titled, “Obtaining A Resource To Read A Symbol,” filed on even date herewith; and Application Ser. No. TBD (Attorney Docket Number 200704393), titled, “Processing Images of A Display,” filed on even date herewith. The disclosures of the above-identified documents are hereby incorporated by reference in their entireties.

### BACKGROUND

Conventional barcodes have enabled items, such as goods for sale or mail within a mail system to be marked and later identified by a suitable barcode reader. These barcodes may be printed in newspapers, magazines, on signs, buses, business cards, embedded in content of web pages, displayed on monitors, and on just about any other print or display that a user might desire.

In addition, it is increasingly becoming an established practice to use barcodes to move content from the Internet to camera-equipped mobile phones and vice versa. In these instances, barcodes are scanned or “imaged” by a barcode reader and then used as a basis for uploading and downloading content and services over the Internet. For instance, a music store may display a monitor having an embedded symbol (or sequence of symbol portions) corresponding to a music track, the name of a song, and an artist. In this example, a camera-equipped mobile phone may “image” the barcode and then use the barcode as a basis to download the music track, the name of the song, and the artist. In this regard, a barcode reader is operating as a high-level application. Conventional camera-equipped devices, however, are often not well tuned for reading barcodes because typically they are tuned for everyday photography. It would therefore be beneficial to provide a system that enables more robust reading of barcodes from conventional camera-equipped devices.

### BRIEF DESCRIPTION OF THE DRAWINGS

Features of the present invention will become apparent to those skilled in the art from the following description with reference to the figures, such reference being made by way of example only, in which:

FIG. 1 illustrates a simplified block diagram of an electronic device containing a symbol reader, according to an embodiment of the invention;

FIG. 2A illustrates a flow diagram of a method of reading a symbol that depicts computer-readable information, according to an embodiment of the invention;

FIG. 2B illustrates a flow diagram of a method of reading a symbol that depicts computer-readable information, according to another embodiment of the invention;

FIG. 3 illustrates a layered architecture of the symbol reader depicted in FIG. 1, according to an embodiment of the invention; and

FIG. 4 shows a block diagram of a computing apparatus configured to implement or execute the methods of FIGS. 2A and 2B, according to an embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and an apparatus for reading a symbol that depicts computer-readable information. In one regard, the method and apparatus disclosed herein are configured to enhance recognition and reading of the symbol by altering at least one imaging parameter of one or more images containing the symbol. Reading, as used herein, may include both recognizing and decoding operations.

In one regard, the method and apparatus disclosed herein are configured to alter at least a region of the one or more images suspected to contain the symbol, to thus substantially minimize the resources required to perform the alteration on the region of the one or more images. As such, through implementation of the method and apparatus disclosed herein, symbols may be read in a faster and more robust manner as compared with conventional methods and apparatuses for reading symbols.

Generally speaking, a symbol, as disclosed herein, may comprise various symbol-types, such as, a barcode or other glyph, that depict computer-readable information. In this regard, a symbol may comprise a barcode or other glyph provided on a printed media. A symbol may also be a visually-symbolic resource that is embedded in a display as any one or more portions of video, frame, image, or picture, etc. In addition, a symbol may be of a symbology taking the form of 10 or 2D barcode symbology, for instance, UPC Symbology (Universal Product Code), Datamatrix Symbology (ISO/IEC16022—International Symbology Specification), QR Codes (JIS X 0510, ISO/IEC 18004:2000, ISO/IEC 18004:2006), Color Codes, EAN 2 etc. The symbols described herein may thus comprise a conventional barcode or a visually-symbolic resource embedded in a display such as disclosed by way of example in PCT Application Serial No. TBD (Attorney Docket Number 200704393), titled, “Processing Images of a Display.”

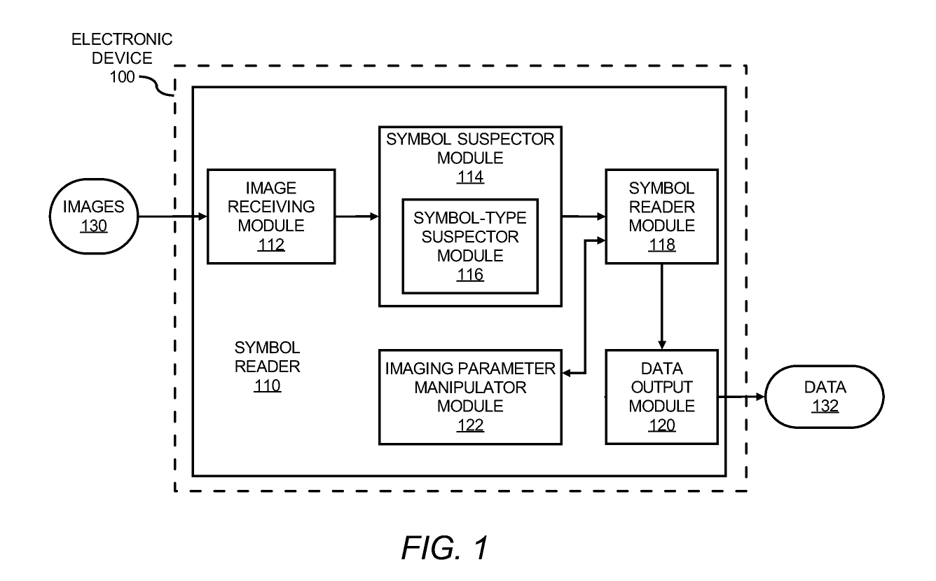

With reference first to FIG. 1, there is illustrated a simplified block diagram of an electronic device 100 containing a symbol reader 110, according to an example. It should be understood that the electronic device 100 may include additional components and that some of the components described herein may be removed and/or modified without departing from the scope of the electronic device 100.

Among other elements, such as a processor (not shown), the electronic device 100 comprises the symbol reader 110, which is depicted as including an image receiving module 112, a symbol suspector module 114, a symbol reader module 118, a data output module 120, and an imaging parameter manipulator module 122. The symbol suspector module 114 is also depicted as including a symbol-type suspector module 116.

The electronic device 100 may comprise any suitable device in which a symbol reader 110 may be implemented. In this regard, the electronic device 100 may comprise a personal computer, a cellular telephone, a personal digital assistant (PDA), etc. In addition, the electronic device 100 may comprise a camera-equipped device, such as, a camera-equipped cellular telephone, a camera-equipped personal computer, smart phone, a camera-equipped PDA, etc. Thus, although not shown, the electronic device 100 may include additional components, such as, one or more processors, digital signal processors, memory, input devices, output devices, image capturing components, etc. According to an example, the symbol reader 110 may comprise a computer-implemented apparatus that uses one or more low-level imaging components of a low-level imaging pipeline (for example, a digital signal processor) of the electronic device 100 to enhance recognition of suspected symbols in captured images. Through use of the one or more low-level imaging components of a low-level imaging pipeline, the symbol reader 110 has finer control over the one or more imaging parameters as compared with the high-level API level.

Generally speaking, the symbol reader 110 is configured to read a symbol contained in one or more captured images 130. In one regard, the symbol reader 110 is configured to read a symbol in the image(s) 130 by altering one or more imaging parameters on at least one region of the image(s) 130 to enhance recognition and reading of a suspected symbol contained in the image(s) 130. According to an example, the symbol reader 110 is configured to suspect the symbol-type of the symbol and to alter the imaging parameter(s) based upon the suspected symbol-type of the symbol.

The symbol reader 110 comprises software, firmware or hardware configured to perform the functions discussed above. In instances where the symbol reader 110 comprises software, the symbol reader 110 may be stored on a computer readable storage medium and may be executed by a controller of the electronic device 100. In instances where the symbol reader 110 comprises firmware or hardware, the symbol reader 110 may comprise a circuit or other apparatus such as a digital signal processor or other chip set configured to perform the functions described herein. In these instances, the modules 112-122 may comprise software modules or other programs or algorithms configured to perform the functions described herein below.

The image receiving module 112 is configured to obtain the one or more images 130. For example, the one or more images 130 are images captured in the optical field of a camera-equipped device, images stored in a memory of the camera-equipped device, images stored in a memory external to the camera-equipped device, etc. As such, in instances where the electronic device 100 comprises a camera, the image receiving module 112 may receive the one or more images 130 directly from the optics of the attached camera. In other instances where the electronic device 100 does not comprise a camera, the image receiving module 112 may receive the one or more images 130 from a separate camera-equipped device or from a memory. In the examples above, the image receiving module 112 may be configured to receive raw and uncompressed versions of the one or more images 130 to thereby facilitate alteration of the low-level imaging parameters on the one or more images 130.

In any regard, the one or more images 130 contain at least one symbol and/or an indicator of the symbol-type. The indicator of the symbol-type may comprise, for instance, text or other indicia that identifies the symbol-type of the symbol contained in the one or more images 130, and may be displayed or otherwise presented near the suspected symbol. In one regard, the symbol-type indicator may be more readily identified than the symbol because the symbol-type indicator may comprise relatively simple features.

The symbol reader 110 may employ the symbol-type indicator in determining how to after at least one imaging parameter to enhance recognition and reading of suspected symbols. More particularly, for instance, the symbol reader 110 may after at least one imaging parameter in a predetermined manner configured to enhance recognition of the particular symbol-type identified by the symbol-type indicator.

The symbol suspector module 114 is configured to suspect that a symbol or a symbol-type indicator is contained in one or more of the images 130. According to an example, the symbol suspector module 114 may suspect that a symbol is contained in one or more of the images 130 if the symbol suspector module 114 actually identifies the presence of a symbol. According to another example, the symbol suspector module 114 may suspect the presence of a symbol if one or more images 130 contain contrasting but similarly shaped elements whose geometric arrangement approximates to one or more of the one- or two-dimensional patterns found in any of the symbologies discussed above.

According to a further example, the symbol suspector module 114 may suspect the presence of a symbol-type indicator by identifying one or more characteristics of the indicator. In this regard, the symbol-type indicator may comprise a relatively unique or a set of relatively unique characteristics, such as, text, colors, shapes, etc., that the symbol suspector module 114 may be programmed to readily distinguish from other objects.

Although particular examples have been provided herein, it should be understood that the symbol suspector module 114 may employ any reasonably suitable means by which to suspect the presence of a symbol or a symbol-type indicator in the one or more images 130.

In the event that the symbol suspector module 114 suspects that one or more of the images 130 contains a symbol, the symbol suspector module 114 sends the one or more images 130 or a portion of the one or more images 130 suspected to include the symbol to the symbol reader module 118. According to an example, the symbol-type suspector module 116 may also analyze the suspected symbol to formulate a suspected symbol-type of the symbol. In addition, or alternatively, the symbol-type suspector module 116 may identify the symbol-type of the suspected symbol based upon information derived from the symbol-type indicator. In this example, the symbol suspector module 114 may also communicate the suspected or the identified symbol-type to the symbol reader module 118. As such, the symbol reader module 118 may more readily determine which type of symbol the symbol reader module 118 should attempt to read.

In the event that the symbol reader module 118 is able to read the suspected symbol, the symbol reader module 118 extracts data 132 from the symbol, for instance, by recognizing and decoding the suspected symbol, and forwards the data 132 to the data output module 120. The data output module 120 outputs the data 132 from the symbol reader 110. According to an example, the data output module 120 may output the data 132 to a data storage of the electronic device 100 and the data 132 may be displayed on a screen of the electronic device 100. According to another example, the data output module 120 may output the data to, for instance, a server via a wireless network connection and the server may return additional data, such as, an advertisement, a ring tone, a video clip, etc., associated with the data 132. It should be readily understood that the examples provided herein are not exhaustive of the possible uses of the data 132 and that many additional uses are possible.

In the event that the symbol reader module 118 is unable to read the suspected symbol, the imaging parameter manipulator module 122 is configured to alter at least one imaging parameter on at least one region of the one or more images to substantially enhance recognition of the suspected symbol. The at least one region of the one or more images 130 may comprise that region identified by the symbol suspector module 114 as suspected to contain a symbol. In this regard, the imaging parameter manipulator module 122 may substantially minimize the alterations on the one or more images 130 to those regions, thereby substantially minimizing the amount of resources required to alter the one or more images 130.

According to an example, the imaging parameter manipulator module 122 alters the at least one imaging parameter by iteratively varying the at least one imaging parameter and forwarding the altered images to the symbol reader module 118. The symbol reader module 118 attempts to read the suspected symbol from the altered one or more images 130. If the symbol reader module 118 is unable to read the symbol from the altered image or portion thereof, the imaging parameter manipulator module 122 varies another at least one imaging parameter. This process may be repeated until the symbol reader module 118 is able to read the suspected symbol or until a predefined condition is reached. The predefined condition may include a predefined length of time, a predefined number of iterations, a predefined number of symbol-types, exhaustion of possible imaging parameter modifications, etc.

According to another example, the imaging parameter manipulator module 122 receives the suspected or the identified symbol-type of the suspected symbol from the symbol reader module 118. In this example, the imaging parameter manipulator module 122 may alter the at least one imaging parameter in a predetermined manner configured to enhance recognition of the suspected or identified symbol-type. The predetermined manner may be established, for instance, through testing of various parameter settings on the various symbol-types. By way of example, when the symbol-type of the suspected symbol comprises DataMatrix, the focus and contrast of the at least one region of the image suspected to contain the symbol image may be altered to enable better recognition of the symbol. As another example, when the symbol-type of the suspected symbol comprises a colorzip code, the tone curve of the at least one region of the image suspected to contain the symbol may be altered to enable better recognition of the symbol.

In any of the examples above, the imaging parameter manipulator module 122 may alter at least one of focus, exposure, tone curve, white balance, offset, color palette, contrast, etc., of at least the region of the one or more images suspected to contain the symbol. As such, the imaging parameter manipulator module 122 may cause one or more capture parameters, such as focus, exposure, etc., to be altered in capturing one or more additional images for improved symbol and/or symbol-indicator recognition. Alternatively, the imaging parameter manipulator module 122 may alter one or more imaging parameters, such as tone curve, white balance, offset, etc., on previously captured images. In one regard, therefore, the imaging parameter manipulator module 122 may alter the at least one imaging parameter through one or more low-level imaging components of a low-level imaging pipeline (for example, a digital signal processor) of the electronic device 100.

The symbol reader module 118 may receive the altered image and/or a second image obtained with the at least one capture imaging parameter altered from the imaging parameter manipulator module 122 and may attempt to read the suspected symbol from the altered image and/or the second image. If the symbol reader module 118 is able to read the symbol, the symbol reader module 118 extracts data 132 from the symbol and forwards the data 132 to the data output module 120, as discussed above. Otherwise, the symbol reader module 118 informs the imaging parameter manipulator module 122 to alter at least the region of the one or more images 130 containing the suspected symbol. The imaging parameter manipulator module 122 and the symbol reader module 118 may repeat this process until the symbol reader module 118 is able to read the suspected symbol or after a predefined condition is reached, as also discussed above.

According to a further example, for instance, when the symbol reader module 118 is unable to read the suspected symbol after the predefined condition has been reached, the data output module 120 may output at least a portion of the one or more images 130 suspected to include the symbol to a symbol identification service (not shown). The symbol identification service may comprise a network-accessible service provided by a content provider and is generally configured to identify multiple types of symbols and symbol-types.

In one regard, the identification service is configured to identify resources that enable the symbol reader module 118 to read (recognize/decode) the multiple types of symbols, and to communicate the identified resources to electronic devices. Examples in which an electronic device 100 may receive resources to enable it to read additional symbol-types are disclosed in POT Application Serial No. TBD (Attorney Docket Number 200704392), titled, “Obtaining a Resource To Read A Symbol” hereby incorporated by its reference in its entirety.

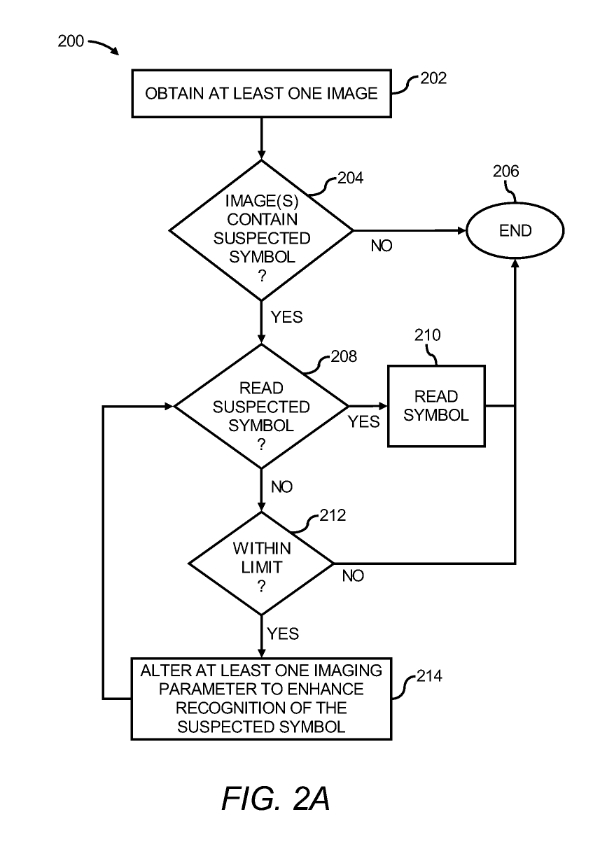

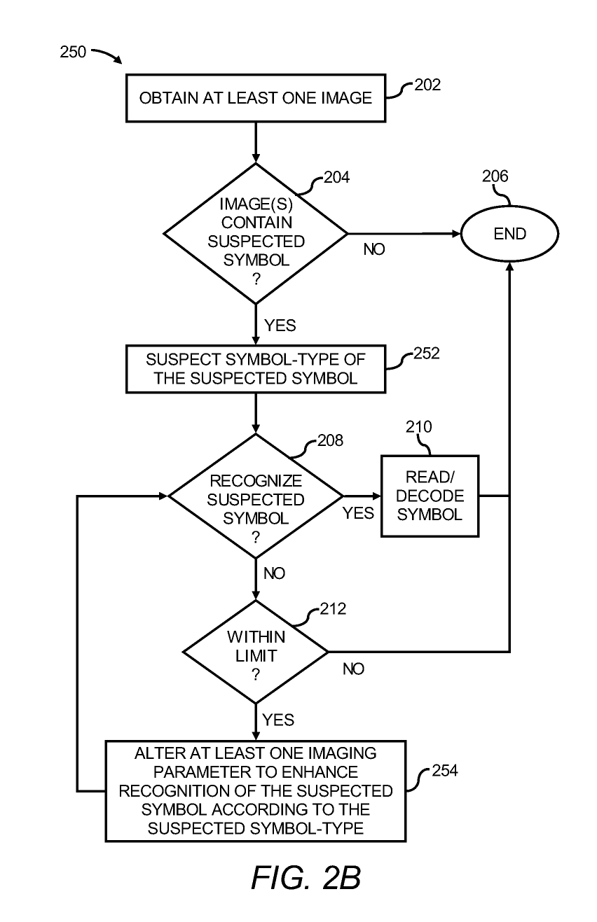

Examples of methods in which the symbol reader 110 may be employed to read a symbol that depicts computer-readable information will now be described with respect to the following flow diagrams of the methods 200 and 250 respectively depicted in FIGS. 2A and 2B. It should be apparent to those of ordinary skill in the art that the methods 200 and 250 represent generalized illustrations and that other steps may be added or existing steps may be removed, modified or rearranged without departing from the scopes of the methods 200 and 250.

The descriptions of the methods 200 and 250 are made with reference to the symbol reader 110 illustrated in FIG. 1 and thus refers to the elements cited therein. It should, however, be understood that the methods 200 and 250 are not intended to be limited to the elements set forth in the symbol reader 110 depicted in FIG. 1. Instead, it should be understood that the methods 200 and 250 may be practiced by a symbol reader having a different configuration than that set forth in the symbol reader 110.

Some or all of the operations set forth in the methods 200 and 250 may be contained as utilities, programs or subprograms, in any desired computer accessible medium operable in the lower-level imaging pipeline. In addition, the methods 200 and 250 may be embodied by computer programs, which may exist in a variety of forms both active and inactive. For example, they may exist as software program(s) comprised of program instructions in source code, object code, executable code or other formats that when compiled are operable in the lower-level imaging pipeline.

Exemplary computer readable storage devices that may be used to store software operable to implement the present invention in the lower-level imaging pipeline include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any electronic device and/or system capable of executing the functions of the above-described embodiments are encompassed by the present invention.

A controller, such as a processor (not shown), ASIC, microcontroller, etc., of the electronic device 100 may implement or execute the symbol reader 110. In addition, or alternatively, the symbol reader 110 may comprise a separate apparatus configured to operate independently of the processor. Furthermore, the methods 200 and 250 may be performed by an imaging pipeline component, such as, a digital signal processor, or any number of imaging pipeline components, which may be implemented in the operation of an image processing device.

According to an example, either of the methods 200 and 250 may be initiated automatically when a camera-equipped electronic device 100 is employed to capture an image. In this example, for instance, either or both of the methods 200 and 250 may run as background programs to an image-capturing application. Thus, for instance, the method 200 and/or 250 may be implemented during a live-view image capturing operation of the camera-equipped electronic device 100, regardless of whether the images are being recorded or merely being viewed through the electronic device 100. In another example, either or both of the methods 200 and 250 may be initiated in response to receipt by the electronic device 100 of a user input to initiate the methods 200 and 250. In this regard, the electronic device 100 may automatically attempt to read a suspected symbol or may be instructed to do so by a user.

With reference first to FIG. 2A, there is shown a flow diagram of the method 200 of reading a symbol that depicts computer-readable information, according to an example,

At step 202, the image receiving module 112 obtains one or more images 130. As discussed above, the image receiving module 112 may obtain the one or more images 130 from one or more different sources.

At step 204, the symbol suspector module 114 determines whether the one or more images 130 contain a suspected symbol. As also described above, the symbol suspector module 114 may determine whether a symbol is suspected to be included in a region of the one or more images 130 in a variety of manners. In addition, the symbol suspector module 114 may determine a confidence level in whether a symbol is suspected to be included in the one or more images 130. The symbol suspector module 114 may determine the confidence level based upon one or more factors, such as, the level to which the suspected symbol matches conditions required to constitute a particular symbol-type. In addition, the symbol suspector module 114 may determine that the one or more images 130 contain a symbol when the confidence level exceeds a predetermined confidence level and that the one or more images 130 do not contain a symbol when the confidence level falls below the predetermined confidence level. The predetermined confidence level may be defined, for instance, based upon testing of the accuracy of various confidence levels.

If the symbol suspector module 114 fails to suspect that the one or more images 130 contain a symbol, the method 200 may end as indicated at step 206. For instance, the method 200 may end even if the symbol suspector module 114 suspects a symbol, but the confidence level falls below the predetermined confidence level. If, however, the symbol suspector module 114 suspects that the one or more images 130 contain a symbol, the symbol reader module 118 attempts to recognize the suspected symbol at step 208.

If the symbol reader module 118 recognizes and is able to read the suspected symbol at step 208, the symbol reader module 118 reads the suspected symbol, as indicated at step 210. At step 210, more particularly, the symbol reader module 118 reads (for instance, decodes) the suspected symbol to identify data 132 associated with the symbol. In addition, the data output module 120 may output the identified data 132 as discussed in greater detail herein above.

If, however, the symbol reader module 118 is unable to read the suspected symbol at step 208, a determination as to whether a limit on a predefined condition has been reached at step 212, The predefined condition may include a predefined length of time, a predefined number of iterations, a predefined number of symbol-types, exhaustion of possible imaging parameter alterations, etc. If the limit on the predefined condition has been reached and is thus outside of the limit at step 212, the method 200 may end at step 206 without the symbol reader module 118 being able to read the suspected symbol. In this instance, the one or more images 130 or portions thereof may be transmitted to a symbol identification service to further enhance reading of the suspected symbol as discussed above,

If the limit on the predefined condition has not been reached at step 212, the image manipulating module 122 alters at least one imaging parameter to enhance recognition of the suspected symbol, as indicated at step 214. In one example, at step 208, the symbol reader module 118 attempts to read the suspected symbol again with the altered at least one imaging parameter applied to at least the region of the one or more images 130 suspected to contain the symbol. In another example, although not explicitly shown, the image receiving module 112 obtains one or more additional images 130 obtained with the least one imaging parameter altered. In this example, at step 208, the symbol reader module 118 attempts to read the suspected symbol from the one or more additional images 130. In either of these examples, steps 208-214 may be repeated until the symbol reader module 118 is able to read the suspected symbol or until the predefined condition limit is reached. Moreover, during each iteration of step 214, the at least one imaging parameter may be varied according to a predetermined routine.

Turning now to FIG. 2B, there is shown a flow diagram of the method 250 of reading a symbol that depicts computer-readable information, according to another example. The method 250 is similar to the method 200 and thus contains some of the same steps described above with respect to the method 200. Descriptions of those similar steps will not be presented again with respect to the method 250, but instead, the descriptions provided with respect to the method 200 is relied upon to provide adequate descriptions of those similar steps.

As shown in FIG. 2B, the method 250 differs from the method 200 in that the method 250 includes a step 252 of suspecting a symbol-type of the suspected symbol. In addition, the step 214 of altering at least one imaging parameter in the method 200 has been replaced with an altering step 254 in the method 250. More particularly, at step 252, the symbol-type suspector module 116 analyzes the suspected symbol or an indicator of the symbol-type to suspect the symbol-type of the suspected symbol. In addition, at step 254, the imaging parameter manipulator module 122 alters at least one imaging parameter in a predetermined manner configured to enhance recognition of the suspected symbol according to the suspected symbol-type.

In one regard therefore, the imaging parameter manipulator module 122 may be programmed with one or more predetermined routines for altering the at least one imaging parameter based upon the suspected symbol-type. In addition, the imaging parameter manipulator module 122 may be programmed to run through the one or more predetermined routines during multiple iterations of steps 208-212 and 254. One result of which may be that the amount of time and resources consumed in altering the at least one imaging parameter may substantially be reduced through implementation of steps 252 and 254.

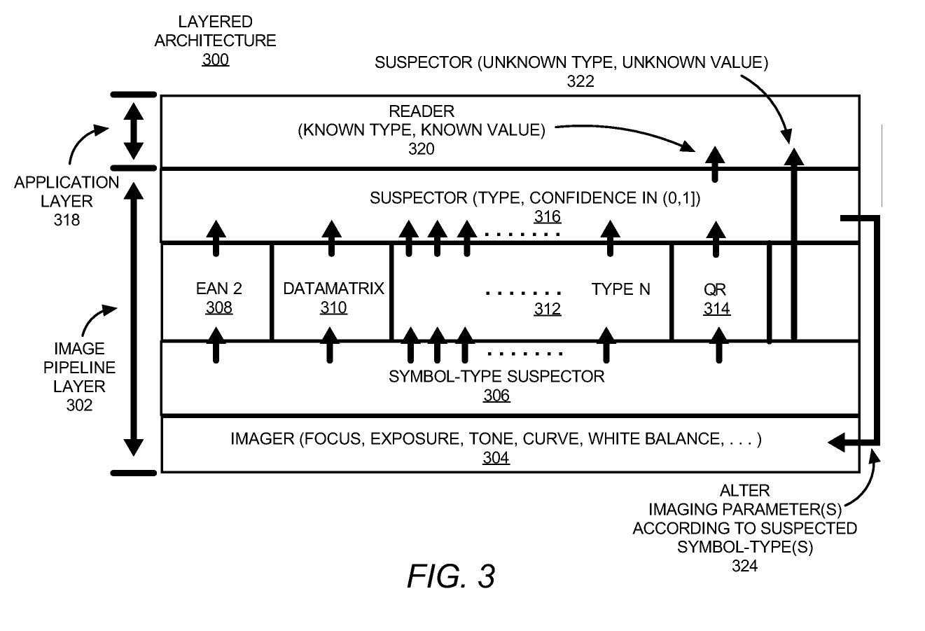

With reference now to FIG. 3, there is shown a layered architecture 300 of the symbol reader 110, according to an example. It should be understood that the layered architecture 300 may include additional layers and that some of the layers described herein may be removed and/or modified without departing from the scope of the layered architecture 300.

As shown in FIG. 3, the layered architecture 300 comprises a lower level image pipeline layer 302 and an application layer 318.

The image pipeline layer 302 contains a symbol-type suspecter layer 306 configured to suspect a symbol-type of a symbol in one or more images 130 (or a region thereof). Upon obtaining the one or more images and suspecting a symbol-type of a suspected symbol, (for example, using a rudimentary algorithm), the symbol recognition module 114 analyzes the one or more images 130 (or the region of the one or more images 130 containing the suspected symbol-type) with respect to the symbol readers (for example, EAN 2 308, DATAMATRIX 310, any other types at 312, and QR type 314). Each symbol reader 308-314 may either be “built-in” (for example, as illustrated for EAN 2, DATAMATRIX, and so forth), or added as a resource (for example, using the symbol identification service).

The symbol reader 110 may run all the local type-specific symbol readers 308-314 over the image (or image region). An analysis of at least a region of the one or more images 130 is made to determine a confidence level for each of the symbol-types at the suspector layer 316. Upon determination that the suspected type is not EAN because, for example, the determined confidence level does not satisfy a predetermined confidence level, an alteration is made to at least one low-level imaging parameter at an imager layer 304. For example, the process may be repeated unless halted (for instance, by exhausting different imaging parameter alterations known to the symbol reader 110.

Upon a determination that the confidence level satisfies a predetermined confidence level, the symbol is read at the reader level 320 in the application layer 318. Although not shown, readers (decoders) may be in the lower-level/layer pipeline. As another example, readers may be in the lower layer, application-layer, or any combination.

As also shown in FIG. 3, if the symbol-type suspector layer 306 does not identify the symbol-type, the image or region thereof suspected to include the symbol is read by the reader layer 320, as noted by the arrow 322.

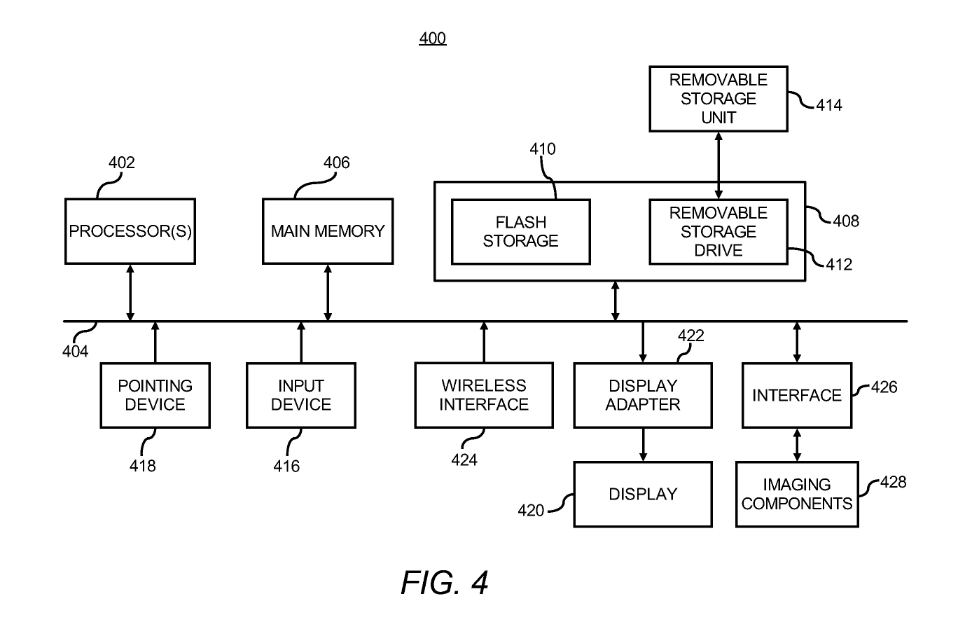

With reference now to FIG. 4, there is shown a block diagram of a computing apparatus 400 configured to implement or execute the methods 200 and 250 depicted in FIGS. 2A and 2B, according to an example. In this respect, the computing apparatus 400 may be used as a platform for executing one or more of the functions described herein above with respect to the symbol reader 110.

The computing apparatus 400 includes a processor 402 that may implement or execute some or all of the steps described in the methods 200 and 250. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more flash storages 410 and/or a removable storage drive 412, representing a removable flash memory card, etc., where a copy of the program code for the methods 200 and 250 may be stored.

The removable storage drive 412 reads from and/or writes to a removable storage unit 414 in a well-known manner. The computing apparatus 400 also includes an input device 416, such as a keyboard, a keypad, functional keys, etc., a pointing device, such as a tracking ball, cursors, etc., and a display 420. A display adaptor 422 may interface with the communication bus 404 and the display 420 and may receive display data from the processor 402 and convert the display data into display commands for the display 420. The processor(s) 402 may communicate over a network, for instance, a cellular network, the Internet, LAN, etc., through a wireless interface 424. In addition, an interface 426 may be used to receive an image or sequence of images from imaging components 428 and to communicate instructions back to the imaging components 428 to vary focus, exposure, etc., as discussed above.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A method of reading a symbol that depicts computer-readable information, said method comprising:
obtaining an image;
determining whether the image contains a suspected symbol;
altering at least one imaging parameter to enhance recognition of the suspected symbol in response to a determination that the image contains a suspected symbol; and
reading the suspected symbol from at least one of an image altered with the at least one imaging parameter and a second image obtained with the at least one imaging parameter altered.

2. The method according to claim 1, wherein altering the at least one imaging parameter further comprises altering at least one image capture parameter, said method further comprising;
obtaining the second image with the at least one image capture parameter altered,

3. The method according to claim 1, further comprising;
identifying at least one region of the image suspected to include the symbol in response to a determination that the image contains a suspected symbol, and wherein altering the at least one imaging parameter further comprises altering the at least one imaging parameter on the at least one region of the image suspected to include the symbol.

4. The method according to claim 1, further comprising:
suspecting a symbol-type of the suspected symbol; and
wherein altering the at least one imaging parameter further comprises altering the at least one imaging parameter in a predetermined manner configured to enhance recognition of the suspected symbol-type.

5. The method according to claim 4, wherein suspecting the symbol-type of the suspected symbol further comprises iteratively comparing the suspected symbol with predetermined symbol-types to suspect the symbol-type of the suspected symbol.

6. The method according to claim 4, wherein suspecting a symbol-type of the suspected symbol further comprises identifying the suspected symbol-type from a symbol-type indicator.

7. The method according to claim 1, wherein obtaining the image further comprises obtaining the image through an imaging pipeline and wherein altering the at least one imaging parameter further comprises altering at least one low-level imaging parameter of the imaging pipeline.

8. The method according to claim 1, wherein altering the at least one imaging parameter further comprises one or both of altering at least one of tone curve, white balance, offset, color palette, and contrast of the obtained image, and at least one of focus and exposure in obtaining the subsequently obtained image.

9. The method according to claim 1, wherein determining whether the image contains a suspected symbol further comprises determining that the image contains a suspected symbol in response to a confidence level that the image contains a suspected symbol exceeding a predetermined confidence level.

10. A computer-implemented apparatus for reading a symbol in a captured image, said apparatus comprising:
an image receiving module configured to obtain images;
a symbol suspector module configured to determine whether an image contains a suspected symbol;
an imaging parameter manipulator module configured to alter at least one imaging parameter to enhance recognition of the suspected symbol; and
a symbol reader module configured to read/decode the suspected symbol from at least one of an image altered with the at least one imaging parameter and a second image obtained with the at least one imaging parameter altered.

11. The computer-implemented apparatus according to claim 10, further comprising:
a symbol-type suspector module configured to suspect a symbol-type of the suspected symbol; and
wherein the imaging parameter manipulator module is configured to alter the at least one imaging parameter in a predetermined manner configured to enhance recognition of the suspected symbol-type.

12. The computer-implemented apparatus according to claim 10, wherein the image receiving module is configured to obtain the images through an imaging pipeline and wherein the imaging parameter manipulator module is configured to alter the at least one low-level imaging parameter of the imaging pipeline.

13. The computer-implemented apparatus according to claim 10, wherein the symbol suspector module is configured to determine that the image contains a suspected symbol in response to a confidence level that the image contains a suspected symbol exceeding a predetermined confidence level.

14. A computer readable storage medium on which is embedded one or more e computer programs, said one or more computer programs implementing a method of reading a symbol that depicts computer-readable information; said one or more computer programs comprising computer readable code for:
obtaining an image;
determining whether the image contains a suspected symbol;
altering at least one imaging parameter to enhance recognition of the suspected symbol in response to a determination that the image contains a suspected symbol; and
reading the suspected symbol from at least one of an image altered with the at least one imaging parameter and a second image obtained with the at least one imaging parameter altered.

15. The computer readable storage medium according to claim 14, further comprising computer readable code for:
suspecting a symbol-type of the suspected symbol; and
wherein altering the at least one imaging parameter further comprises altering the at least one imaging parameter in a predetermined manner configured to enhance recognition of the suspected symbol-type.
